(19) United States
(12) Patent Application Publication
(10) Pub. No.: US 2017/0095802 A1
(43) Pub. Date: Apr. 6, 2017

(54) Stability of Doped-Zirconia as Support Oxide for Copper-Manganese Zero-PGM Catalysts

(71) Applicant: Clean Diesel Technologies, Inc., Oxnard, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Oxnard, CA (US)

(21) Appl. No.: 14/872,972

(22) Filed: Oct. 1, 2015

(51) Int. Cl. B01J 23/889; B01J 23/02; B01J 21/06; B01J 23/00

(52) U.S. Cl. CPC B01J 23/8892; B01J 23/005; B01J 23/02; B01J 21/066

(57) ABSTRACT

The present disclosure describes bulk powder Zero-PGM material compositions including a CuMn₂O₄ spinel structure supported on doped zirconia support oxides powders, including Ba, Sr, and Ti at different dopant loadings produced by different conventional synthetic methods. BET-surface area and XRD analysis are performed for a plurality of doped zirconia support oxides to compare the thermal stability, before and after deposition of Cu—Mn spinel. Additionally, bulk powder ZPGM catalyst compositions are subjected to a steady-state isothermal sweep test to determine NO conversion capabilities. The selected support oxide material compositions are capable of providing increased surface areas for improved thermal stability leading to a more effective utilization of ZPGM catalyst materials with enhanced NO conversion and improved thermal stability for TWC applications.

### BACKGROUND

### Field of the Disclosure

This disclosure relates generally to catalyst materials, and more particularly, to variations of catalyst material compositions including a plurality of support oxides.

### Background Information

Catalysts within catalytic converters have been used to decrease the pollution associated with exhaust from various sources, such as, automobiles, boats, and other engine-equipped machines. Significant pollutants contained within the exhaust gas of gasoline engines include carbon monoxide (CO), unburned hydrocarbons (HC), and nitrogen oxides (NOₓ), among others.

Conventional gasoline exhaust systems employ three-way catalysts technology and are referred to as three way catalyst (TWC) systems. TWC systems convert the CO, HC and NOₓ into less harmful pollutants. Typically, TWC systems include a substrate structure upon which promoting oxides are deposited. Bimetallic catalysts, based on platinum group metals (PGM), are then deposited upon the promoting oxides. PGM materials include Pt, Rh, Pd, Ir, or combinations thereof. Some TWC systems have been developed to incorporate new catalytic materials. These new catalytic materials have to be highly active and thermally stable under fluctuating exhaust gas conditions so as to meet the same emission standards that TWC systems employing PGM materials currently meet.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost TWC system exhibiting catalytic properties substantially similar to or better than the catalytic properties exhibited by TWC systems employing PGM catalyst materials.

### SUMMARY

The present disclosure describes Zero-Platinum Group Metal (ZPGM) material compositions including a Cu—Mn spinel supported on a plurality of doped zirconia support oxides to develop suitable ZPGM catalyst materials for TWC applications. Further, the ZPGM material compositions provide increased chemical stability as well as thermal stability for improved performance of TWC systems.
In some embodiments, the bulk powder ZPGM catalyst compositions including a Cu—Mn spinel supported on a plurality of doped zirconia support oxides are produced via Incipient Wetness (IW) and co-precipitation methodologies. In these embodiments, the effect of Cu—Mn deposition onto a plurality of doped zirconia support oxides is analyzed for increased performance of NO conversion and thermal stability.
In some embodiments, the bulk powder ZPGM catalyst material compositions of a Cu—Mn spinel supported on a plurality of doped zirconia support oxides are subjected to a BET surface area analysis at a plurality of temperatures. In other embodiments, XRD analyses are performed to determine the spinel phase formation and stability of the spinel structures. In further embodiments, the bulk powder ZPGM catalyst material compositions are subjected to an isothermal steady-state sweep test to assess/verify NO conversion.

According to the principles of this present disclosure, test results of bulk powder ZPGM catalyst material compositions exhibiting significant NO conversion performance and thermal stability can be used in the development of improved ZPGM catalyst materials for TWC systems. The disclosed bulk powder ZPGM catalyst compositions can contribute to improvements in the overall catalytic conversion capacity thereby providing an essential advantage given the economic factors involved when completely or substantially PGM-free materials are used to manufacture ZPGM catalysts for a plurality of TWC applications.
Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 is a graphical representation illustrating steady-state sweep test results comparing NO conversions at particular R-values of a bulk powder Cu—Mn spinel supported on a plurality of doped zirconia support oxides, according to an embodiment.

FIG. 2 is a graphical representation illustrating an X-ray diffraction (XRD) phase stability analysis of a Sr-doped zirconia support oxide as well as a bulk powder Cu—Mn spinel supported on a Sr-doped zirconia support oxide, according to an embodiment.

FIG. 3 is a graphical representation illustrating an XRD phase stability analysis of a bulk powder Cu—Mn spinel supported on a Sr-doped zirconia support oxide calcined at about 800° C. as well as a bulk powder Cu—Mn spinel supported on Sr-doped zirconia support oxide calcined at about 1000° C., according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Definitions

As used here, the following terms have the following definitions:

“Brunauer-Emmett-Teller (BET) surface area analysis” refers to an analytical technique for determining specific surface areas of powders by physical adsorption of a gas on the surface of the solid, and by calculating the amount of adsorbed gas corresponding to a mono-molecular layer on the surface.

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Conversion” refers to the chemical alteration of at least one material into one or more other materials.
“Co-precipitation” refers to the carrying down by a precipitate of substances normally soluble under the conditions employed.

“Incipient wetness (IW)” refers to the process of adding solution of catalytic material to a dry support oxide powder until all pore volume of support oxide is filled out with solution and mixture goes slightly near saturation point.

“Lean condition” refers to exhaust gas condition with an R-value less than 1.

“Platinum Group Metal (PGM)” refers to platinum, palladium, ruthenium, iridium, osmium, and rhodium.

“R-value” refers to the value obtained by dividing the reducing potential of the catalyst by the oxidizing potential of the catalyst.

“Rich condition” refers to exhaust gas condition with an R-value greater than 1.

“Spinel” refers to any minerals of the general formulation AB₂O₄ where the A ion and B ion are each selected from mineral oxides, such as, magnesium, iron, zinc, manganese, aluminum, chromium, or copper, among others.

“Support oxide” refers to porous solid oxides, typically mixed metal oxides, which are used to provide a high surface area, which aids in oxygen distribution and exposure of catalysts to reactants, such as, NO_{X}, CO, and hydrocarbons.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“Treating, treated, or treatment” refers to drying, firing, heating, evaporating, calcining, or mixtures thereof.

“X-ray diffraction (XRD) analysis” refers to a rapid analytical technique for identifying crystalline material structures, including atomic arrangement, crystalline size, and imperfections in order to identify unknown crystalline materials (e.g., minerals, inorganic compounds).

“Zero platinum group (ZPGM) catalyst” refers to a catalyst completely or substantially free of PGM.

Description of the Disclosure

The present disclosure describes Zero-PGM (ZPGM) material compositions including a Cu—Mn spinel supported on a plurality of doped zirconia support oxides to develop suitable ZPGM catalyst materials with enhanced surface area and NO conversion capacity. These ZPGM material compositions provide high chemical reactivity as well as thermal stability for improved performance of three-way catalyst (TWC) systems.

Bulk Powder ZPGM Material Composition and Preparation
In some embodiments, the ZPGM material composition samples are produced by employing a general formulation CuₓMn₃₋ₓO₄ spinel, in which x is a variable for different molar ratios. In these embodiments, x has a value of about 1.0.

In some embodiments, bulk powder ZPGM material composition samples are produced including a Cu—Mn spinel supported on a plurality of doped zirconia support oxides, according to formulations in Table 1. In these embodiments, the ZPGM material composition samples are produced by physically mixing the appropriate amount of Cu nitrate, and Mn nitrate solutions. Further to these embodiments, the mixed Cu nitrate and Mn nitrate solution is drop wise added to the corresponding doped zirconia support oxide powders by incipient wetness (IW) methodology, according to formulations in Table 1. Still further to these embodiments, the resulting catalyst material is dried overnight at about 120° C. and calcined at a plurality of temperatures. In an example, calcination is performed at about 800° C. for about 5 hours. In another example, calcination is performed at about 1000° C. for about 5 hours. In these embodiments, the calcined material of Cu—Mn spinel supported on the corresponding doped zirconia support oxide is ground into a fine grain bulk powder.

TABLE 1
Cu—Mn spinel supported on variations of doped zirconia support oxides
for Samples 1A, 1B, 2A, 2B, 3A, and 3B.

| Sample | Bulk Powder Catalyst |
|---|---|
| No. | Samples |
| 1A | Cu—Mn/ZrO₂—5% BaO |
| 1B | Cu—Mn/ZrO₂—10% BaO |
| 2A | Cu—Mn/ZrO₂—5% SrO |
| 2B | Cu—Mn/ZrO₂—10% SrO |
| 3A | Cu—Mn/ZrO₂—10% TiO₂ |
| 3B | Cu—Mn/ZrTiO₄ |

Preparation of Cu—Mn Spinel Supported on ZrO₂-5% BaO or ZrO₂-10% BaO Support Oxide

In some embodiments, bulk powder ZPGM composition Samples 1A and 1B are produced from a binary Cu₁Mn₂O₄ spinel composition supported on ZrO₂-5% BaO and ZrO₂-10% BaO support oxide powders, respectively. In these embodiments, ZrO₂-5% BaO and ZrO₂-10% BaO support oxide powders are produced using IW methodology. Further to these embodiments, the production of the Ba-doped zirconia support oxide powders include Ba nitrate and ZrO₂ employing 5 wt % Ba loading for Sample 1A, and 10 wt % Ba loading for Sample 1B. In these embodiments, a portion of the Sample 1A mixture of Ba nitrate and zirconia and the Sample 1B mixture of Ba nitrate and zirconia are dried overnight and calcined at about 800° C. for about 5 hours. Further to these embodiments, another portion of the Sample 1A mixture of Ba nitrate and zirconia is dried overnight, and calcined at about 1000° C. for about 5 hours. In these embodiments, the calcined material of Ba-doped zirconia is subsequently ground into a fine bulk powder.
In some embodiments, a Cu—Mn solution is produced by physically mixing the appropriate amount of Cu nitrate and Mn nitrate solutions. In these embodiments, the mixed Cu nitrate and Mn nitrate solution is drop wise added to each of the ZrO₂-5% BaO and ZrO₂-10% BaO support oxide powders using IW methodology. Further to these embodiments, the resulting catalyst material is dried overnight at about 120° C. and calcined at a plurality of temperatures. In these embodiments, calcination is preferably performed at about 800° C. for about 5 hours. Further to these embodiments, the calcined material of Cu—Mn spinel supported on either the ZrO₂-5% BaO support oxide or the ZrO₂-10% BaO support oxide is ground into a fine grain bulk powder.

Preparation of Cu—Mn Spinel Supported on ZrO₂-5% SrO or ZrO₂-10% SrO Support Oxide

In some embodiments, bulk powder ZPGM composition Samples 2A and 2B are produced from a binary Cu₁Mn₂O₄ spinel composition supported on ZrO₂-5% SrO and ZrO₂-10% SrO support oxide powders, respectively. In these embodiments, ZrO₂-5% SrO and ZrO₂-10% SrO support oxide powders are produced using IW methodology. Further to these embodiments, the production of the Sr-doped zirconia support oxide powders include Sr nitrate and ZrO₂ employing 5 wt % Sr loading for Sample 2A, and 10 wt % Sr loading for Sample 2B. In these embodiments, a portion of the Sample 2A mixture of Sr nitrate and zirconia and the Sample 2B mixture of Sr nitrate and zirconia are dried overnight, and calcined at about 800° C. for about 5 hours. Further to these embodiments, another portion of the Sample 2A mixture of Sr nitrate and zirconia is dried overnight, and calcined at about 1000° C. for about 5 hours. In these embodiments, the calcined material of Sr-doped zirconia is subsequently ground into a fine bulk powder.
In some embodiments, a Cu—Mn solution is produced by physically mixing the appropriate amount of Cu nitrate and Mn nitrate solutions. In these embodiments, the mixed Cu nitrate and Mn nitrate solution is drop wise added to each of the ZrO₂-5% SrO and ZrO₂-10% SrO support oxide powders using IW methodology. Further to these embodiments, the resulting catalyst material is dried overnight at about 120° C. and calcined at a plurality of temperatures. In an example, calcination is performed at about 800° C. for about 5 hours. In another example, calcination is performed at about 1000° C. for about 5 hours. In these embodiments, the calcined material of Cu—Mn spinel supported on either the ZrO₂-5% SrO support oxide or the ZrO₂-10% SrO support oxide is ground into a fine grain bulk powder.

Preparation of Cu—Mn Spinel Supported on ZrO₂-10% TiO₂ Support Oxide

In some embodiments, bulk powder ZPGM composition Sample 3A is produced from binary Cu₁Mn₂O₄ spinel composition supported on ZrO₂₋10% TiO₂ support oxide powder. In these embodiments, ZrO₂₋10% TiO₂ support oxide powder is produced using IW methodology. Further to these embodiments, production of the Ti-doped zirconia support oxide powder includes titanium oxysulfate (TiOSO₄.2H₂O) and ZrO₂ employing 10 wt % Ti loading for Sample 3A. In these embodiments, a portion of the Sample 3A mixture of Ti and zirconia is dried overnight, and calcined at about 800° C. for about 5 hours. Further to these embodiments, another portion of the Sample 3A mixture of Ti and zirconia is dried overnight, and calcined at about 1000° C. for about 5 hours. In these embodiments, the calcined material of Ti-doped zirconia is subsequently ground into a fine bulk powder.

In some embodiments, a Cu—Mn solution is produced by physically mixing the appropriate amount of Cu nitrate and Mn nitrate solutions. In these embodiments, the mixed Cu nitrate and Mn nitrate solution is drop wise added to the ZrO₂-10% TiO support oxide powder using IW methodology. Further to these embodiments, the resulting catalyst material is dried overnight at about 120° C. and calcined at a plurality of temperatures. In some embodiments, calcination is preferably performed at about 800° C. for about 5 hours. In these embodiments, the calcined material of Cu—Mn spinel supported on ZrO₂-10% TiO support oxide is ground into a fine grain bulk powder.

Preparation of Cu—Mn Spinel Supported on ZrTiO₄ Support Oxide

In some embodiments, bulk powder ZPGM composition Sample 3B is produced from binary Cu₁Mn₂O₄ spinel composition supported on ZrTiO₄ support oxide powder. In these embodiments, ZrTiO₄ support oxide is produced using a co-precipitation methodology. Further to these embodiments, production of the ZrTiO₄ support oxide powder includes titanium oxysulfate (TiOSO₄.2H₂O) and zirconium nitrate ZrO(NO₃)₂.11.5H₂O at pH=8, employing a base solution, such as NaOH, and a total loading of Ti of about 17wt % for the composition of Sample 3B. In these embodiments, after washing and filtering, the mixture is dried overnight and calcined at about 800° C. for about 5 hours. Further to these embodiments, the calcined material of ZrTiO₄ is ground into a fine bulk powder.

In some embodiments, a Cu—Mn solution is produce by physically mixing the appropriate amount of Cu nitrate and Mn nitrate solutions. In these embodiments, the mixed Cu nitrate and Mn nitrate solution is drop wise added to the ZrTiO₄ support oxide powder using IW methodology. Further to these embodiments, the resulting catalyst material is dried overnight at about 120° C. and calcined at a plurality of temperatures. In some embodiments, calcination is preferably performed at about 800° C. for about 5 hours. In these embodiments, the calcined material of Cu—Mn spinel supported on ZrTiO₄ support oxide is ground into a fine grain bulk powder.

BET-Surface Area Analysis

In some embodiments, bulk powder ZPGM catalyst material compositions of Cu—Mn spinel supported on a plurality of support oxide powders are subjected to a Brunauer-Emmett-Teller (BET) surface area analysis at a plurality of temperatures. In these embodiments and prior any measurement, the bulk powder material composition samples are degassed to remove water and other contaminants from the bulk powder material composition samples before the surface area can be accurately measured. Further to these embodiments, the powder composition samples are degassed in a vacuum environment at a plurality of temperatures. In these embodiments, the preferred temperature for degassing the powder composition samples is the highest temperature that will not damage the structure of the powder composition samples. Further to these embodiments, the highest temperature that will not damage the structure of the powder composition samples is chosen to shorten the degassing time. In these embodiments, a minimum of about 0.5 g of powder composition sample is required for the successful BET surface area determination. Further to these embodiments, powder composition samples are placed in glass cells to be degassed and analyzed by the BET-surface area measurement analyzer. An example of a BET surface analyzer is the Horiba SA-9600 available from Horiba Instruments, Inc. of Irvine, Calif., USA.

BET-Surface Area Analysis of Doped Zirconia Support Oxides

In some embodiments, BET-surface area analyses are performed on a plurality of doped zirconia support oxides as illustrated in Table 2.

TABLE 2
Surface area analysis of a plurality of doped zirconia support oxides.

| | Support | SA of Support | SA of Support |
|---|---|---|---|
| Sample | Oxide | Oxide at 800° C. | Oxide at 1,000° C. |
| 1A | ZrO₂—5% BaO | 30.7 | 17.0 |
| 1B | ZrO₂—10% BaO | 27.1 | 14.7 |
| 2A | ZrO₂—5% SrO | 31.4 | 19.0 |
| 2B | ZrO₂—10% SrO | 25.8 | 7.9 |
| 3B | ZrO₂—10% TiO₂ | 28.8 | 8.9 |
| 3C | ZrTiO₄ | 24.0 | 7.6 |

In these embodiments, support oxides calcined at about 800° C. exhibit higher levels of surface area when compared to surface areas of support oxides calcined at about 1000° C. Further to these embodiments, the support oxides employed in Samples 1A and 1B and calcined at about 1000° C. exhibit a decrease of the surface area from about 30.7 m²/g and about 27.1 m²/g to about 17.0 m²/g and about 14.7 m²/g, respectively. In these embodiments, the support oxides employed in Samples 2A and 2B and calcined at about 1000° C. exhibit a decrease of the surface area from about 31.4 m²/g and about 25.8 m²/g to about 19.0 m²/g and about 7.9 m²/g, respectively. Further to these embodiments, the support oxides employed in Samples 3A and 3B and calcined at about 1000° C. exhibit a significant decrease of the surface area from about 28.8 m²/g and about 24.0 m²/g to about 8.9 m²/g and about 7.6 m²/g, respectively.

Isothermal Steady State Sweep Test Procedure

In some embodiments, an isothermal steady-state sweep test is performed on catalyst samples at an inlet temperature of about 450° C. and employing a gas stream having 11-point R-values from about 2.00 (rich condition) to about 0.80 (lean condition) to measure the NO, CO, and HC conversions. In an example, the isothermal steady-state sweep test is performed employing a gas stream having R-values from about 1.40 (rich condition) to about 0.90 (lean condition) to measure the NO, CO, and HC conversions.

In these embodiments, the space velocity (SV) in the isothermal steady-state sweep test is set at about 40,000 h⁻¹. Further to these embodiments, the gas feed employed for the test is a standard TWC gas composition, with variable O₂ concentration, in order to adjust R-value from rich condition to lean condition during testing. In these embodiments, the standard TWC gas composition includes about 8,000 ppm of diluted inert CO, about 400 ppm of C₃H₆, about 100 ppm of C₃H₈, about 1,000 ppm of NO, about 2,000 ppm of H₂, about 10% of CO₂, and about 10% of H₂O. The quantity of O₂ within the gas mix is varied to regulate the Air/Fuel (A/F) ratio within the range of R-values to adjust the gas stream.

Comparison of NO Conversion of Cu—Mn Spinel on a Plurality of Doped Zirconia Support Oxides

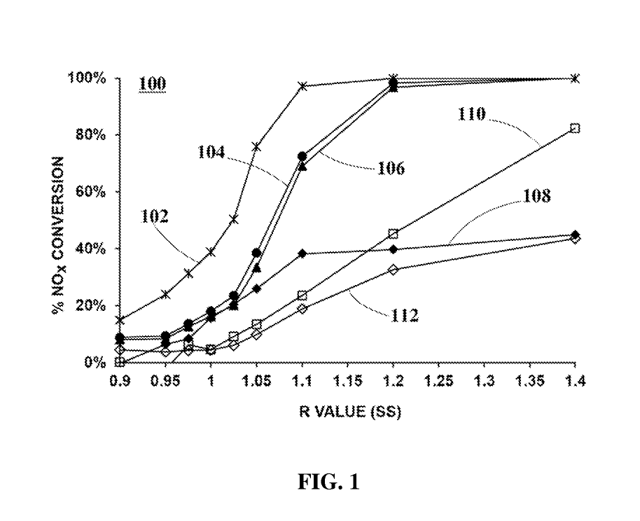

FIG. 1 is a graphical representation illustrating steady-state sweep test results comparing NO conversions at particular R-values of a bulk powder Cu—Mn spinel supported on a plurality of doped zirconia support oxides, according to an embodiment. In FIG. 1, catalyst performance 100 includes conversion curve 102 (solid line with asterisks), conversion curve 104 (solid line with solid circles), conversion curve 106 (solid line with solid triangles), conversion curve 108 (solid line with solid diamonds), conversion curve 110 (solid line with squares), and conversion curve 112 (solid line with diamonds).
In some embodiments, conversion curve 102 illustrates NO conversion values associated with bulk powder Cu—Mn spinel supported on ZrO₂-5% BaO support oxide (Sample 2A). In these embodiments, conversion curve 104 illustrates NO conversion values associated with bulk powder Cu—Mn spinel supported on ZrO₂-10% SrO support oxide (Sample 2B). Further to these embodiments, conversion curve 106 illustrates NO conversion values associated with bulk powder Cu—Mn spinel supported on ZrO₂-5% BaO support oxide (Sample 1A). In these embodiments, conversion curve 108 illustrates NO conversion values associated with bulk powder Cu—Mn spinel supported on ZrTiO₄ support oxide (Sample 3B). Further to these embodiments, conversion curve 110 illustrates NO conversion values associated with bulk powder Cu—Mn spinel supported on ZrO₂-10% BaO support oxide (Sample 1B). In these embodiments, conversion curve 112 illustrates NO conversion values associated with bulk powder Cu—Mn spinel supported on ZrO₂-10% TiO₂ support oxide (Sample 3A).

In some embodiments, the catalytic activity of the aforementioned bulk powder samples is analyzed at R-value of 1.10. In these embodiments and at R-value of 1.10, conversion curve 102 (Sample 2A) exhibits the highest level of NO conversion at about 97.2%, while conversion curve 104 (Sample 2B) and conversion curve 106 (Sample 1A) exhibit NO conversion at about 72.5% and about 68.2%, respectively. Further to these embodiments, conversion curve 108 (Sample 3B), conversion curve 110 (Sample 1B), and conversion curve 112 (Sample 3A) exhibit significantly lower levels of NO conversion at about 38.5%, about 23.7%, and about 18.9%, respectively.

In other embodiments, ZPGM catalyst material composition Samples 2A, 2B and 1A exhibit substantial improvements of NO conversions. In these embodiments, increasing Ba doping from about 5% to about 10% exhibit lower NO conversion activities, as illustrated by conversion curve 110 (Sample 1B). Further to these embodiments, ZPGM catalyst material composition Samples 3A and 3B, including Ti-doping, slightly increase NO conversion, as illustrated by conversion curves 112 (Sample 3A) and 108 (Sample 3B).

In these embodiments, the ZPGM catalyst material composition including bulk powder Cu—Mn spinel that is supported on a ZrO₂-5% BaO support oxide (Sample 2A) exhibits a significantly high level of NO conversion as well as the highest surface area stability after deposition of Cu—Mn spinel, and further calcination at about 1000° C.

XRD Analysis for Support Oxide and Cu—Mn Spinel Phase Formation and Stability

According to some embodiments, Cu—Mn spinel phase formation and stability are subsequently analyzed/measured using X-ray diffraction (XRD) analyses. In these embodiments, XRD data is then analyzed to determine if the structure of the Cu—Mn spinel remains stable after calcination. If the structure of the Cu—Mn spinel becomes unstable, new phases will form within the ZPGM catalyst material compositions. Further to these embodiments, different calcination temperatures may result in different Cu—Mn spinel phases being formed within the Cu—Mn spinel thereby indicating instability within the Cu—Mn spinel.
In some embodiments, XRD patterns are measured using a powder diffractometer employing Cu Ka radiation in the 2-theta range band of about 15°-100° with a step size of about 0.02° and having a dwell time of about 1 second increments. In these embodiments, the tube voltage and the current are set to about 40 kV and about 30 mA, respectively. The resulting diffraction patterns are analyzed using the International Center for Diffraction Data (ICDD) database to identify phase formation. Examples of powder diffractometer include the MiniFlex™ powder diffractometer available from Rigaku® of Woodlands, Tex., USA.
In other embodiments, the disclosed support oxides are also subjected to XRD analyses. In these embodiments, XRD data is analyzed to determine if the structure of the disclosed support oxides remains stable after calcination.

XRD Analysis of Support Oxides and ZPGM Catalyst Material Compositions

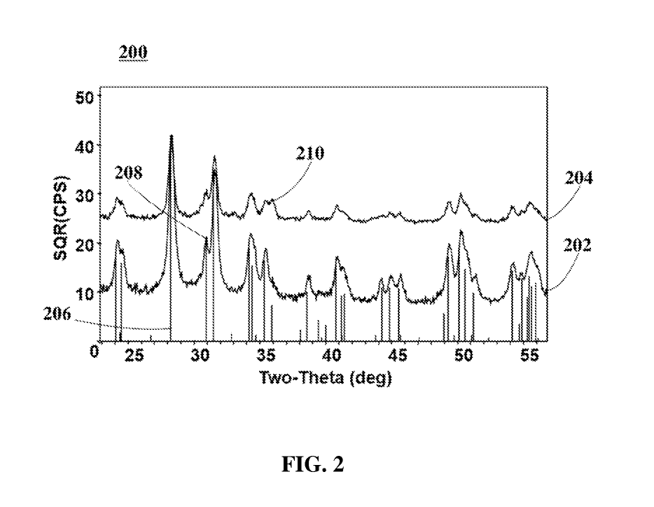

FIG. 2 is a graphical representation illustrating an X-ray diffraction (XRD) phase stability analysis of a Sr-doped zirconia support oxide as well as a bulk powder Cu—Mn spinel supported on a Sr-doped zirconia support oxide (Sample 2A) , according to an embodiment. In FIG. 2, XRD analysis 200 includes XRD spectrum 202, XRD spectrum 204, solid line 206, solid line 208, and diffraction peak 210.

In some embodiments, XRD spectrum 202 illustrates a bulk powder ZrO₂-5% SrO support oxide calcined at about 1000° C., and XRD spectrum 204 illustrates a bulk powder Cu—Mn spinel supported on a ZrO₂-5% SrO support oxide (Sample 2A) and calcined at about 800° C. In these embodiments, zirconia arranged in a monoclinic structure is used for producing the ZrO₂-5% SrO support oxide of each sample. Further to these embodiments and referring to the support oxide portion of each sample, after the deposition of Sr onto the zirconia support oxide and calcination at about 800° C. and 1000° C. respectively, zirconia arranged in a monoclinic structure is still detected as illustrated by solid line 206. Because zirconia is still detected, the doping of the zirconia with 5% Sr does not change the stability of the zirconia. In these embodiments, a new SrZrO₃ phase having a smaller intensity is produced after calcination at about 1000° C., as illustrated by solid line 208. Further to these embodiments, a Cu—Mn spinel phase is detected at about 800° C. indicating the Cu—Mn spinel is stable at about 800° C., as illustrated by diffraction peak 210.

XRD Analysis of Cu—Mn Spinel Supported on ZrO₂-5% SrO Support Oxide

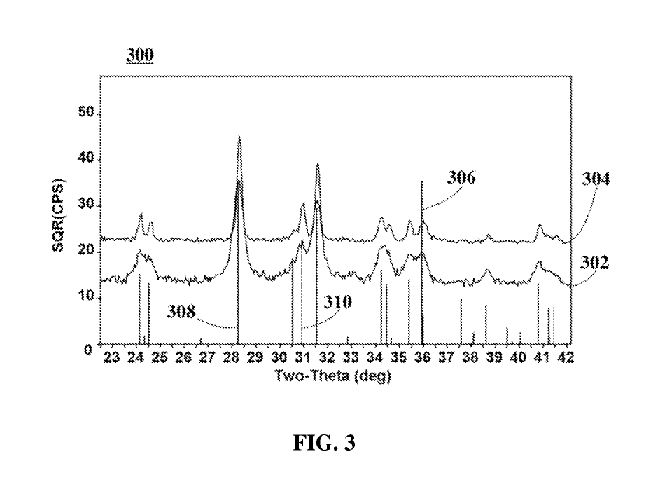

FIG. 3 is a graphical representation illustrating an XRD phase stability analysis of a bulk powder Cu—Mn spinel supported on Sr-doped zirconia support oxide calcined at about 800° C. as well as a bulk powder Cu—Mn spinel supported on Sr-doped zirconia support oxide calcined at about 1000° C., according to an embodiment. In FIG. 3, XRD analysis 300 includes XRD spectrum 302, XRD spectrum 304, solid line 306, solid line 308, and solid line 310.

In some embodiments, XRD spectrum 302 illustrates a bulk powder CuMn₂O₄ spinel supported on a ZrO₂-5% SrO support oxide (Sample 2A) and calcined at about 800° C., and XRD spectrum 304 illustrates a bulk powder CuMn₂O₄ spinel supported on a ZrO₂-5% SrO support oxide (Sample 2A) calcined at about 1000° C. In these embodiments, a Cu—Mn spinel phase arranged in a cubic structure is produced (after calcination at about 800° C.) on the ZrO₂-5% SrO support oxide, as illustrated by solid line 306. Further to these embodiments, the Cu—Mn spinel phase is still detected after calcination at about 1000° C. In these embodiments, a zirconia phase arranged in a monoclinic structure is detected after calcination at about 1000° C., as illustrated by solid line 308. Further to these embodiments, a SrZrO₃ phase of less intensity is detected after calcination at about 1000° C., as illustrated by solid line 310.

In some embodiments, the improved thermal stability exhibited by ZrO₂-5% SrO support oxide, employed in Sample 2A, indicates ZrO₂-5% SrO support oxide should be considered as a more stable support oxide for Cu—Mn spinels. In these embodiments, when calcined at both 800° C. and 1000° C. the zirconia within the ZrO₂-5% SrO support oxide remained as a monoclinic zirconia and obstructed the conversion of the zirconia into tetrahedral zirconia after the deposition of Cu—Mn spinels.

In summary, test results demonstrated that ZPGM bulk powder catalyst samples, including ZrO₂-5% SrO support oxide, exhibited the highest NO conversion and surface area stability after deposition of Cu—Mn spinel and calcination at about 1000° C. Additionally, ZrO₂-5% SrO support oxide maintained spinel phase stability at high temperatures required for a plurality of TWC applications. The improved thermal stability properties of the disclosed ZPGM catalyst material compositions can be used in a large number of TWC catalyst applications with similar or improved performance compared to existing catalyst including PGM and rare metals.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A support oxide for a catalytic composition, comprising a zirconia doped by at least one selected from the group consisting of Ba, Sr, and Ti.

2. The support oxide of claim 1, wherein the zirconia is doped by Ba to form a BaO—ZrO₂ support oxide.

3. The support oxide of claim 2, wherein the BaO—ZrO₂ support oxide comprises about 0.5% to about 50% by weight BaO.

4. The support oxide of claim 3, wherein the BaO—ZrO₂ support oxide comprises about 5% to about 10% by weight BaO.

5. The support oxide of claim 3, wherein the BaO—ZrO₂ support oxide comprises about 5% by weight BaO.

6. The support oxide of claim 1, wherein the zirconia is doped by Sr to form a SrO—ZrO₂ support oxide.

7. The support oxide of claim 6, wherein the SrO—ZrO₂ support oxide comprises about 0.5% to about 50% by weight SrO.

8. The support oxide of claim 7, wherein the SrO—ZrO₂ support oxide comprises about 5% to about 10% by weight SrO.

9. The support oxide of claim 7, wherein the SrO—ZrO₂ support oxide comprises about 5% by weight SrO.

10. The support oxide of claim 7, wherein the SrO—ZrO₂ support oxide comprises about 10% by weight SrO.

11. A catalytic composition comprising a ZPGM catalyst and at least one support oxide including a zirconia doped by at least one selected from the group consisting of Ba, Sr, and Ti.

12. The catalytic composition of claim 11 wherein the ZPGM catalyst includes a Cu—Mn spinel.

13. The support oxide of claim 11, wherein the zirconia is doped by Ba to form a BaO—ZrO₂ support oxide, wherein the BaO—ZrO₂ support oxide comprises about 0.5% to about 50% by weight BaO.

14. The support oxide of claim 12, wherein the zirconia is doped by Ba to form a BaO—ZrO₂ support oxide, and wherein the BaO—ZrO₂ support oxide comprises about 0.5% to about 50% by weight BaO.

15. The support oxide of claim 13, wherein the BaO—ZrO₂ support oxide comprises about 5% to about 10% by weight BaO.

16. The support oxide of claim 14, wherein the BaO—ZrO₂ support oxide comprises about 5% by weight BaO.

17. The support oxide of claim 11, wherein the zirconia is doped by Sr to form a SrO—ZrO₂ support oxide, and wherein the SrO—ZrO₂ support oxide comprises about 0.5% to about 50% by weight SrO.

18. The support oxide of claim 12, wherein the zirconia is doped by Sr to form a SrO—ZrO₂ support oxide, and wherein the SrO—ZrO₂ support oxide comprises about 0.5% to about 50% by weight SrO.

19. The support oxide of claim 17, wherein the SrO—ZrO₂ support oxide comprises about 5% to about 10% by weight SrO.

20. The support oxide of claim 18, wherein the SrO—ZrO₂ support oxide comprises about 5% to about 10% by weight SrO.
